(19) United States
(12) Patent Application Publication
(10) Pub. No.: US 2014/0325198 A1
(43) Pub. Date: Oct. 30, 2014

(54) ELECTRONIC DEVICE AND LOADING METHOD OF CONTROL PROGRAM

(71) Applicant: Asmedia Technology Inc., New Taipei City (TW)

(72) Inventors: Chin-Lung WU, New Taipei City (TW); Sheng-Chang PENG, New Taipei City (TW)

(73) Assignee: Asmedia Technology Inc., New Taipei City (TW)

(21) Appl. No.: 14/252,252

(22) Filed: Apr. 14, 2014

(30) Foreign Application Priority Data
Apr. 24, 2013 (CN) 201310145914.2

(51) Int. Cl. G06F 9/445

(52) U.S. Cl. CPC G06F 9/44505
USPC 713/2

(57) ABSTRACT

An electronic device comprises a first memory unit, a processing unit and an operating interface. The processing unit is electronically connected to the first memory unit. The operating interface is electronically connected to the processing unit. When the processing unit is communicated with a host device via the operating interface, the processing unit executes a loading program and transmits a notification signal to the host device. The host device transmits at least one control program to the first memory unit according to the notification signal. When the control program is transmitted, the processing unit is reset and then executes the control program stored in the first memory unit. The stored firmware can be added or modified, and the circuit layout is simplified.

### CROSS-REFERENCE TO RELATED APPLICATION

This application claims the priority benefit of China application serial No. 201310145914.2, filed on Apr. 24, 2013. The entirety of the above-mentioned patent application is hereby incorporated by reference herein and made a part of specification.

### BACKGROUND OF THE INVENTION

1. Field of the Invention

The disclosure relates to an electronic device and a loading method of control program.

2. Description of the Related Art

Firmware is a kind of software embedded in hardware devices. Firmware is a necessary control program (or called as a program code) for the basic hardware initialization and the peripheral control, which is used to control and coordinate the integrated circuit to make the device operate normally. Thus, the firmware is widely used in kinds of electronic devices, such as a host computer and an electronic device cooperating with a host computer, the electronic device may be an optical drive, a CD writer, a hard drive, a memory card, a wireless base station, an IP router, a digital camera, or a modem.

Generally speaking, the firmware of the electronic device can be stored in a read-only memory or a flash memory. When the firmware is stored in the read-only memory, since the data stored in the read-only memory cannot be modified or deleted, the user will not be able to add, modify or modify the firmware stored in the read-only memory. In other words, the user cannot make the electronic device adapt to a new hardware environment or make the electronic device have an additional function or optimize the electronic device just by updating the firmware.

In addition, when the firmware of the electronic device is stored in a flash memory, the firmware should be transmitted from a flash memory to a random access memory first, and then executed by a processing unit when the electronic device needs to execute the firmware. Although it allows the users to add or modify the firmware when the firmware is stored in a flash memory, at least one additional flash memory is needed for storing the firmware, and thus the layout of the circuit is limited.

### BRIEF SUMMARY OF THE INVENTION

The disclosure provides an electronic device and a loading method of control program. The stored firmware can be added, modified or changed, and the circuit layout is simplified.

An electronic device comprises a first memory unit, a processing unit and an operating interface. The processing unit is electronically connected to the first memory unit. The operating interface is electronically connected to the processing unit. When the processing unit is communicated with a host device via the operating interface, the processing unit executes a loading program and transmits a notification signal to the host device. The host device transmits at least one control program to the first memory unit according to the notification signal. After the control program is transmitted, the processing unit is resets and then executes the control program stored in the first memory unit. The format of the control program is a single-row serial data and has no communication protocol data.

A loading method of a control program is applied to an electronic device and the electronic device is connected to a host device. The loading method comprising: a processing unit of the electronic device executes a loading program and transmits a notification signal to the host device; the host device transmits at least one control program to a first memory unit of the electronic device according to the notification signal. After the control program is transmitted, the processing unit is reset and then executes the control program stored in the first memory unit. The format of the control program is a single-row serial data and has no communication protocol data.

The processing unit of the electronic device executes the loading program to inform the host device to transmit at least one control program to the first memory unit of the electronic device. The processing unit is reset and then executes the control program stored in the first memory unit after the control program is transmitted. The stored firmware can be added or modified, and the circuit layout is simplified.

### BRIEF DESCRIPTION OF THE DRAWINGS

FIG. 1A is a schematic diagram showing an electronic device in an embodiment;

FIG. 1B is a flowchart showing a loading method of a control program in an embodiment;

FIG. 2 is a schematic diagram showing the format of a control program in an embodiment; and

FIG. 3 is a schematic diagram showing another electronic device in another embodiment.

### DETAILED DESCRIPTION OF THE EMBODIMENTS

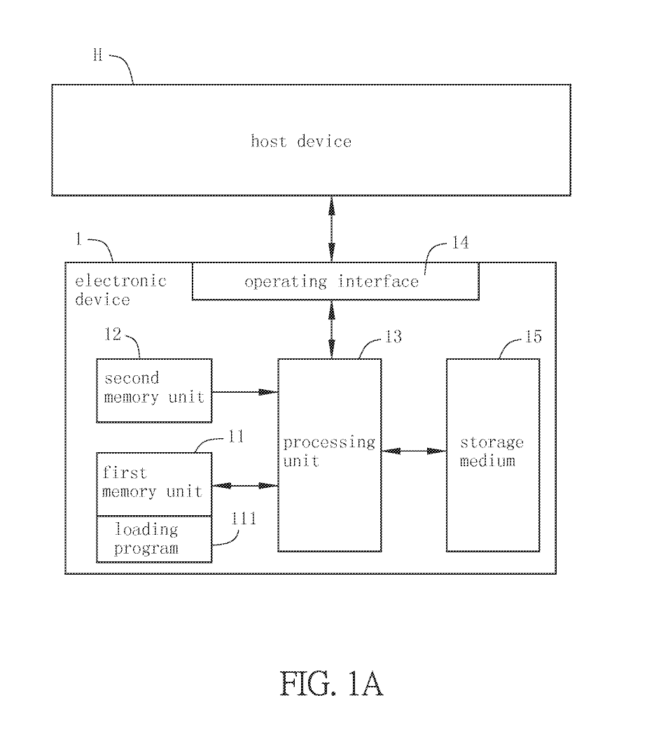

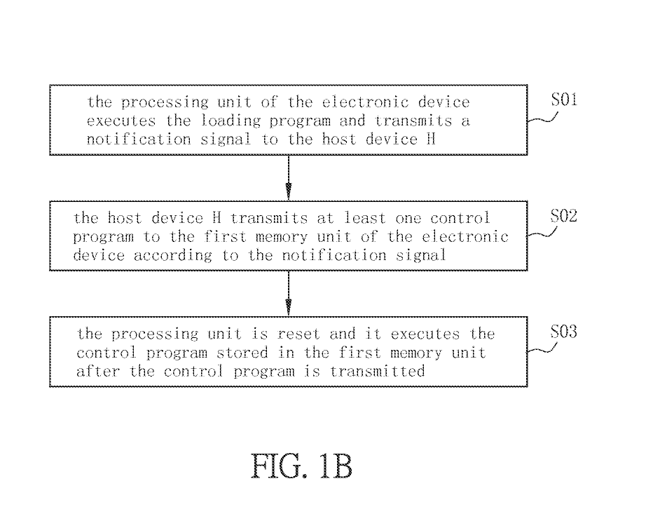

FIG. 1 is a schematic diagram showing an electronic device in an embodiment. An electronic device 1 includes a first memory unit 11, a second memory unit 12, a processing unit 13, an operating interface 14 and a storage medium 15. The processing unit 13 is electronically connected to the first memory unit 11, the second memory unit 12, the operating interface 14 and the storage medium 15, respectively. A loading program 111 is stored in the first memory unit 11. The first memory unit 11 is a random access memory (RAM), the second memory unit 12 is a read only memory (ROM), the processing unit 13 is a central processing unit (CPU), and the storage medium 15 is a flash memory.

The electronic device 1 is communicated with a host device H via the operating interface 14. The operating interface 14 may be a peripheral component interconnect (PCI) interface or a peripheral component interconnect express (PCI-E) interface. The host device H may be a desktop computer or a notebook computer. In addition, the electronic device 1 may include other components according to function requirements.

Please refer to FIG. 1B and FIG. 1A, the loading method of a control program may be applied to the electronic device 1. The loading method includes steps S01 to S03. In step S01, the processing unit 13 of the electronic device 1 executes the loading program 111 and transmits a notification signal to the host device H. When the electronic device 1 is communicated with the host device H via the operating interface 14, the electronic device 1 executes the interface command handle routine. In detail, when the electronic device 1 is communicated with the host device H, the processing unit 13 executes the program code stored in the second memory unit 12 to perform the self-test and initialization, for example, it confirms whether a register, a flag and a timer are able to operate normally and loads system default values accordingly.

Then, the electronic device 1 receives the loading program 111 transmitted from the host device H via the operating interface 14, and the loading program 111 is stored in the first memory unit 11. The loading program 111 is firmware, as shown in FIG. 1A, the loading program 111 may be written into the end address of the storage space of the first memory unit 11. When the loading program 111 is completely stored in the first memory unit 11, the processing unit 13 executes the loading program 111 and transmits the notification signal to the host device H via the operating interface 14.

In step S02, the host device H transmits at least one control program to the first memory unit 11 of the electronic device 1 according to the notification signal. When the host device H receives the notification signal from the electronic device 2, at least one control program is transmitted to the electronic device 1. The control program is firmware. Compared to the program code stored in the second memory unit 12, the control program may be firmware providing additional features for the electronic device 1 or further optimizing the processing performance of the electronic device 1.

The control program is transmitted to the first memory unit 11 via the operating interface 14, and the loading program 111 receives the control program. The control program is stored in the first memory unit 11. The host device H determines the required control program according to the notification signal transmitted from the electronic device 1. In addition, the control program is written sequentially from the forefront addresses of the storage space of the first memory unit 11.

In step S03, the processing unit 13 is resets and then executes the control program stored in the first memory unit 11 after the control program is transmitted. The host device H informs the electronic device 1 after the control programs which need to be transmitted are all transmitted to the electronic device 1. Then, the processing unit 13 of the electronic device 1 is reset and then executes the control program which is written in step S02. During the resetting process of the processing unit 13, the electronic device 1 still has power, in other words, the first memory unit 11 can still preserve the control program completely. After the processing unit 13 is reset, the pointer executed by the program code can point to the lowest address of the first memory unit 11, that is the forefront address of the storage space in the first memory unit 11, and the processing unit 13 executes the control program in the first memory unit 11.

Therefore, the electronic device 1 and the loading method of control program not only can save a flash memory for storing firmware to simplify the circuit structure but also can load additional control program from the host device H according to the requirements of the user or the electronic device 1 to add or modify the functions of the electronic device 1 or enhance the performance of the electronic device 1.

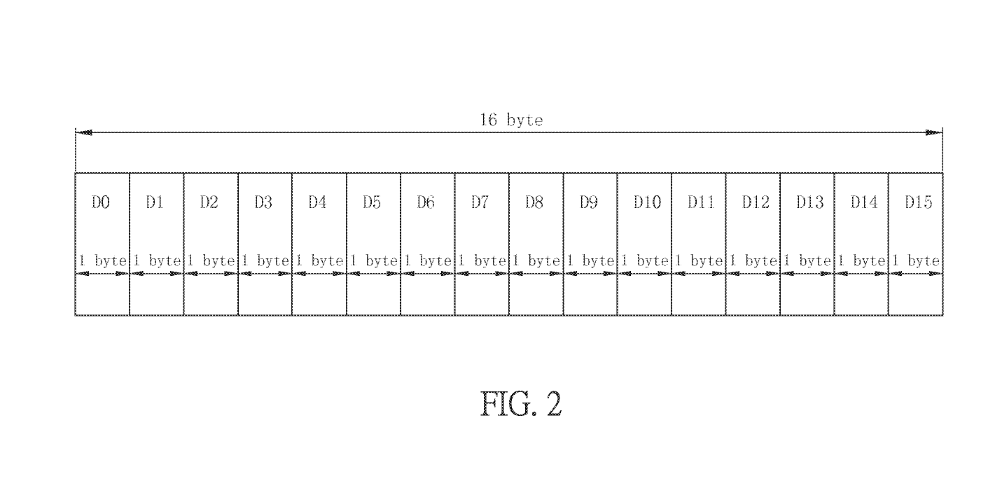

In addition, the format of the control program received via the loading program 111 is a single-row serial data. Please refer to FIG. 2. FIG. 2 is a schematic diagram showing the format of a control program in an embodiment. The format of the control program includes 16 bytes, that is, the data packet transmitted from the host device H to the electronic device 2 includes 16 bytes. The data D0 to D15 of each byte are valid data. The format of the control program is not necessary to have a communication protocol data, such as CMD op code, length, offset address and/or memory type, which is not limited herein.

Compared to the conventional control program, the control program in embodiments significantly reduces the overhead of the extra data packet to make the data package only include actual data. Therefore, it avoids the waste of bandwidth in the transmission of the control program (data) and improves the transmission speed of the control program (data).

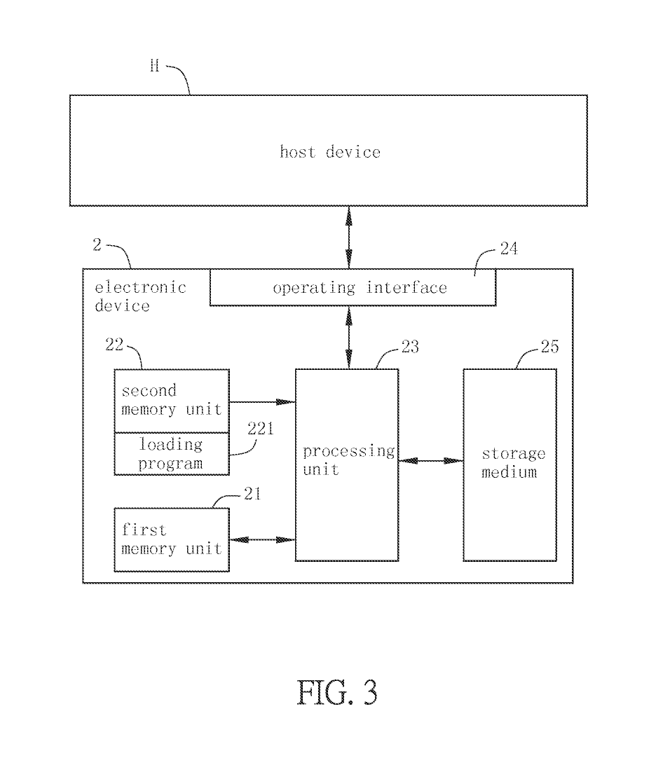

Please refer to FIG. 3. FIG. 3 is a schematic diagram showing another electronic device 2 in an embodiment. The electronic device 2 includes a first memory unit 21, a second memory unit 22, a processing unit 23, an operating interface 24 and storage medium 25. The processing unit 23 is electronically connected to the first memory unit 21, the second memory unit 22, the operating interface 24 and the storage medium 25, respectively. The first memory unit 21 is a random access memory (RAM), the second memory unit 22 is a read only memory (ROM), the processing unit 23 is a central processing unit (CPU), and the storage medium 25 is a flash memory. The difference between the electronic device 2 and the electronic device 1 is that the loading program 221 is stored in the second memory unit 22 in the manner of pre-recorded.

The loading method of the control program also can be applied to the electronic device 2. When the electronic device 2 is communicated with the host device H, the processing unit 23 executes the program code stored in the second memory unit 22 to perform the self-test and initialization and loads system default valves. Then, the electronic device 2 executes the loading program 221 stored in the second memory unit 22 and transmits the notification signal to the host device H. Then, the electronic device 2 will execute the step S01 to S03, which is omitted herein.

In conclusion, according to the electronic device and the method of loading a control program in embodiments, the processing unit of the electronic device executes the loading program to inform the host device to transmit at least one control program to the first memory unit of the electronic device. The processing unit is reset and it executes the control program stored in the first memory unit after the control program is transmitted. Consequently, the stored firmware can be added, modified or changed, and the circuit layout is simplified.

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An electronic device , comprising:
a first memory unit;
a processing unit electronically connected to the first memory unit; and
an operating interface electronically connected to the processing unit,
wherein when the processing unit is communicated with a host device via the operating interface, the processing unit executes a loading program and transmits a notification signal to the host device, the host device transmits at least one control program to the first memory unit according to the notification signal, after the control program is transmitted, the processing unit is reset and then executes the control program stored in the first memory unit.

2. The electronic device according to claim 1, wherein the format of the control program is a single-row serial data.

3. The electronic device according to claim 1, wherein all data in format of the control program is valid data.

4. The electronic device according to claim 1, wherein the processing unit is communicated with the host device via the operating interface, the electronic device executes an interface command handle routine, and the loading program transmitted from the host device is stored in the first memory unit.

5. The electronic device according to claim 1, further comprising:
a second memory unit electronically connected to the processing unit; and
a storage medium electronically connected to the processing unit.

6. The electronic device according to claim 5, wherein when the processing unit is communicated with the host device via the operating interface, the electronic device executes an interface command handle routine, and the processing unit executes the loading program stored in the second memory unit.

7. A loading method of a control program, applied to an electronic device which is communicated with a host device, the loading method comprising:
a processing unit of the electronic device executing a loading program and transmitting a notification signal to the host device; and
the host device transmitting at least one control program to a first memory unit of the electronic device according to the notification signal,
wherein after the control program is transmitted, the processing unit is reset and then executes the control program stored in the first memory unit.

8. The loading method according to claim 7, wherein before the processing unit executes the loading program, further comprising:
the electronic device communicated with the host device via the operating interface;
the electronic device executing the interface command handle routine and receiving the loading program from the host device; and
the loading program stored in the first memory unit.

9. The loading method according to claim 7, wherein all data in format of the control program is valid data.

10. The loading method according to claim 7, wherein before the processing unit executes the loading program, further comprising:
the electronic device communicated with the host device via the operating interface; and
the electronic device executing the interface command handle routine, wherein the loading program is stored in the second memory unit of the electronic device.
